(19) United States
(12) Patent Application Publication
(10) Pub. No.: US 2013/0166400 A1
(43) Pub. Date: Jun. 27, 2013

(54) CASH REGISTER COMMUNICATION INTERFACE DOCK

(71) Applicants: Nam H. Nguyen, Houston, TX (US); Kent E. Biggs, Tomball, TX (US)

(72) Inventors: Nam H. Nguyen, Houston, TX (US); Kent E. Biggs, Tomball, TX (US)

(73) Assignee: Hewlett-Packard Development Company LP

(21) Appl. No.: 13/335,936

(22) Filed: Dec. 23, 2011

(51) Int. Cl. G06Q 30/00; G08B 29/00

(52) U.S. Cl. 705/16; 340/5.73

(57) ABSTRACT

A dock comprises a communication interface to communicate with a portable electronic device having a user input interface. The dock additionally includes a cash register communication interface to communicate with a cash register.

### BACKGROUND

Portable electronic devices or mobile devices, such as tablets, are sometimes used for taking orders and assisting with credit card or debit card payments. The use of such portable electronic devices is not well-suited for cash transactions.

### BRIEF DESCRIPTION OF THE DRAWINGS

FIG. 1 is a schematic illustration of an example cash register communication interface dock.

FIG. 2 is a schematic illustration of an example point-of-sale system incorporating an example implementation of the dock of FIG. 1.

FIG. 3 is a flow diagram of an example method that may be carried out by the system of FIG. 2.

FIG. 4 is a schematic illustration of another example point-of-sale system incorporating an example implementation of the dock of FIG. 1.

FIG. 5 is a schematic illustration of an example implementation of the point-of-sale system of FIG. 2.

FIG. 6 is a schematic illustration of another example implementation of the point-of-sale system of FIG. 2.

### DETAILED DESCRIPTION OF THE EXAMPLE IMPLEMENTATIONS

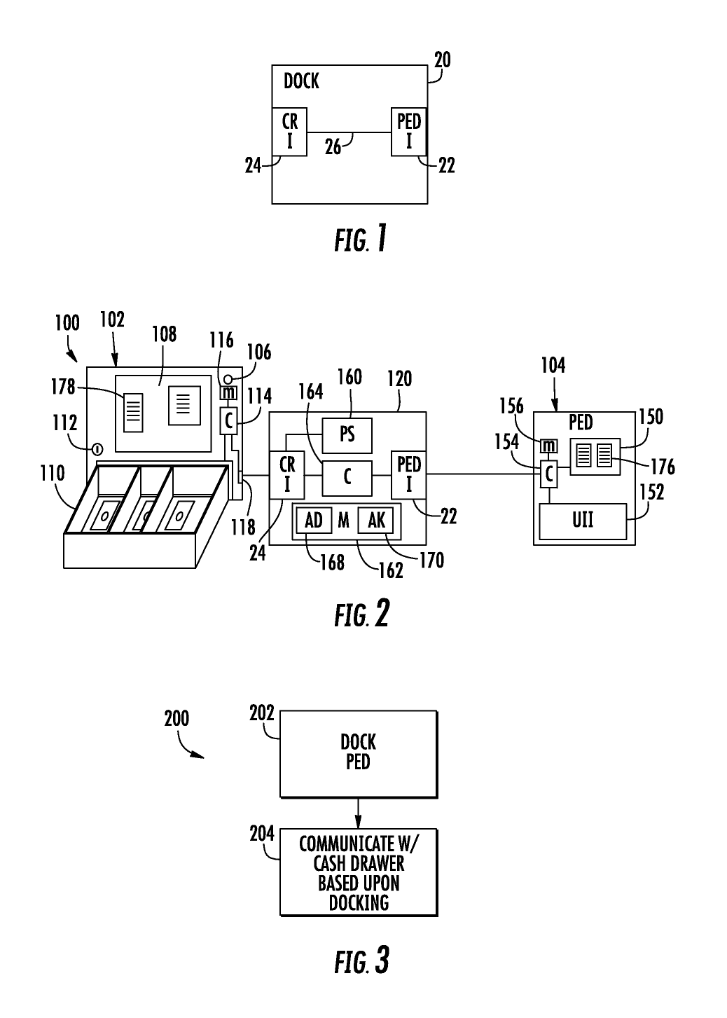

FIG. 1 schematically illustrates an example cash register communication interface dock 20. As will be described hereafter, dock 20 facilitates communication between a portable electronic device having a user interface, such as those used for taking point-of-sale orders, and a cash register unit. Dock 20 facilitates use of the portable electronic device in cash transactions.

In the example illustrated, dock 20 comprises a single self-contained unit or assembly comprising portable electronic device interface 22 and cash register unit interface 24. Portable electronic device interface 22 comprises an interface by which dock 20 may communicate with a portable electronic device, such as a tablet, personal data assistant, handheld scanner, barcode reader, a smart phone or any other portable electronic device that may be used to take point-of-sale orders. In one implementation, portable electronic device interface 22 comprises a physical connector by which the body of the portable electronic device physically attaches or physically docks to dock 20, wherein data communications are further facilitated through the physical connector. In another implementation, portable electronic device interface 22 comprises a port, such as a Universal Serial Bus (USB) type connector, by which an electrical cord that may be used to electrically connect or electrically dock the portable electronic device to dock 20. In yet another implementation, portable electronic device interface 22 may be configured to facilitate wireless communication between dock 20 and the portable electronic device such that the portable electronic device may be wirelessly docked at dock 20. Examples of wireless electronic devices or mechanisms include, but are not limited to, radio frequency communication devices, microwave communication devices, infrared short-range communication devices and the like. For example, in one implementation, portable electronic device interface 22 may comprise a wireless card for facilitating wireless communication between dock 20 and a portable electronic device.

Cash register interface 24 comprises an interface by which dock 20 may communicate with a cash register. For purposes of this disclosure, a cash register refers to a device or unit minimally including a cash drawer in which currency is deposited and withdrawn to facilitate a cash transaction. A cash register may additionally include an electronic lock, an electronic display or monitor, and a user input by which transactions may be entered. In some implementations, the cash register may merely comprise a cash drawer with and electronic latch or lock and a connector for connecting to dock 20.

In one implementation, cash register interface 24 comprises a physical connector by which the body of the cash register physically attaches to dock 20, wherein data communications are further facilitated through the physical connector. In another implementation, cash register interface 24 comprises a port, such as a RJ12 connector, by which an electrical cable may be used to connect the cash register to dock 20. In yet another implementation, cash register interface may comprise an electronic device configured to facilitate wireless communication between dock 20 and the cash register. Examples of wireless electronic devices or mechanisms include, but are not limited to, radiofrequency communication devices, microwave communication devices, infrared short-range communication devices and the like. For example, in one implementation, cash register interface 22 may comprise a wireless card for facilitating wireless communication between dock 20 and the cash register.

As schematically indicated by communication path 26, portable electronic device interface 22 is communicatively coupled to cash register interface 24. For purposes of this disclosure, the term “communicatively coupled” refers to that two members are directly or indirectly connected such that electronic data or electronic data signals may be transmitted from one member to the other member directly or via intermediate data or signal transmission components. The general term “coupled” refers to the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

Communication path 26 facilitates the transfer of data or electronic signals from a portable electronic device connected to interface 22, across dock 20, to a cash register connected to interface 24. In one implementation, the communication channel provided by communication path 26 is immediately provided and opened upon and in response to connection of the portable electronic device interface 22 and a cash register unit to interface 24. In another implementation, the communication channel remains closed despite such connections until authorization is completed. For example, upon being connected to interface 22, opening of a communication channel between the portable electronic device and dock 20 may be delayed until the portable electronic device has been authorized. Such authorization may be carried out by dock 20 itself.

Upon being connected to interface 24, opening of a communication channel between the cash register unit and dock 20 may be delayed until the cash register unit has been authorized. Such authorization may be carried out by dock 20 itself. In other implementations, upon being connected interface 22, opening of a communication channel between the portable electronic device and dock 20, as well as a cash register unit connected to interface 24, may be delayed until the cash register unit carries out an authorization process and authorizes the connected portable electronic device. In one implementation, the cash register unit may authorize both dock 20 and the portable electronic device prior to permitting communication with the cash register unit.

Once a communication channel is open across communication path 26, data from the connected portable electronic device 22 may be transferred to the connected cash register unit. As a result, transaction information (such as a customer's order) input to the portable electronic device remote from the cash register unit (such as that a customer's table or at a remote location in a store or warehouse) and temporarily stored on the portable electronic device may be transmitted to the connected cash register unit via interface 24. Thus, this information upon the portable electronic device does not need to be reentered to the cash register unit when a cash transaction is taking place and the cash register is being used.

In one example, the uploading or transmission of data from the docked portable electronic device to the connected cash register unit automatically takes place or is automatically triggered in response to connection of the portable electronic device interface 22 and a cash register unit communicatively coupled to interface 24. In another implementation, the transfer of data may be delayed despite such connections until authorization is completed. For example, upon being connected to interface 22, transfer data from the portable electronic device to dock 20 may be delayed until the portable electronic device has been authorized. Such authorization may be carried out by dock 20 itself.

Upon being connected to interface 24, the transfer of data from the cash register unit to dock 20, and ultimately to the connected portable electronic device, may be delayed until the cash register unit has been authorized. Authorization may be carried out by dock 20 itself. Such authorization processes may be carried out by one or more of numerous authorization techniques such as the use of authorization keys or passwords stored on such devices, read from a card or token, or entered through user interfaces of such devices, biometric authorization processes such as fingerprint recognition, facial recognition or voice recognition and the like.

In other implementations, the initiation of the transfer of data may occur, with or without an authorization, in response to the additional step of a person entering a data transfer command be a keyboard or other user interface device on either the docked portable electronic device or the connected cash register unit.

In some implementations, the opening of such a communication channel may also trigger the transfer of data or controls originating with dock 20. For example, in response to a portable electronic device being connected to interface 22 while dock 20 is already connected to a cash register unit, dock 20 may automatically trigger the opening of a cash drawer associated with the connected cash register unit. In response to a portable electronic device being connected interface 22 while dock 20 is ready connect to a cash register unit, dock 20 may automatically trigger the presentation of selected data or information upon a display associated with the connected cash register unit. For example, the completion of connection of a portable electronic device to interface 22 may cause dock 20 to itself trigger the display of a particular graphical user interface, icon or other data upon the display of the cash register unit. As a result, a salesperson, waiter or host a simply need to connect his or her portable electronic device to automatically bring up an appropriate menu, order form or screen, inventory listing, delivery information or schedule, credit rating, customer data or history and the like on the display of the cash register unit to facilitate such a commercial transaction. In other implementations, the automatic presentation of information on a display of the cash register unit may alternatively be triggered by completion of additional steps such as the additional step of authorization.

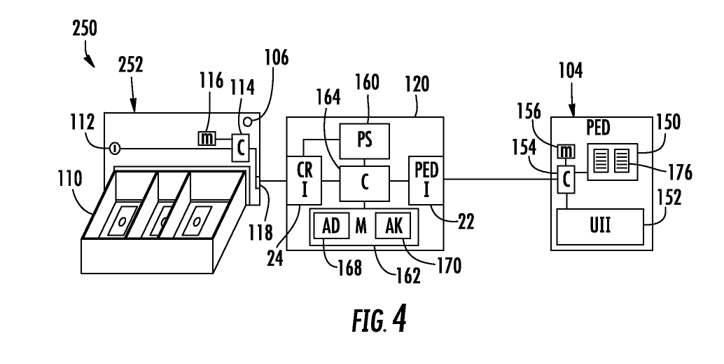

FIG. 2 schematically illustrates an example point-of-sale system 100. Point-of-sale system 100 comprises cash register unit or cash register 102, portable electronic device 104 and cash register communication interface dock 120, a particular implementation of dock 20. Cash register 102 comprises an electronic, electric or computerized cash register which facilitates commercial transactions, especially commercial transactions involving cash or other currency. Cash register 102 comprises power switch 106, display 108, cash drawer 110, lock 112, controller 114 and memory 116.

Power switch 106 comprises a button, toggle other device by which a person may manually power or turn on cash register 102. Display 108 comprises a screen or monitor by which data may be visibly presented. In one implementation, display 108 may comprise a touchscreen, also serving as a user input or user interface for cash register 102. In other implementations, a separate user interface, such as a keyboard or keypad may be utilized with cash register 102. Although illustrated as being incorporated as part of the unit or body which also provides cash drawer 110, in other implementations, display 108 may be a separate display structure independent of cash drawer 110, wherein the separate display structure or monitor is connected to and controlled by controller 114 of display 102.

Cash drawer 110 comprises a currency containing and receiving drawer or other chamber movable between an open state or position (shown in FIG. 2) providing access to its interior and a closed position retracted within the body of cash register 102, denying access to its interior. Lock 112 comprises a mechanism by which cash drawer 110 may be selectively retained in the closed position. In one implementation, lock 112 is configured to be electrically controlled or actuated between a locked state securing drawer 110 and an unlocked state. Although lock 112 is illustrated as being configured to receive a physical key for actuation in addition to electronically controlled actuation, in other implementations, lock 112 may alternatively be actuated solely by electronic or electrical actuation, such as in response to signals from controller 114.

Controller 114 comprises one or more processing units configured to generate control signals directing the presentation of information upon display 108. In the implementation illustrate, controller 114 further generates control signals directing the actuation of lock 112 and the opening of cash drawer 110. For purposes of this application, the term “processing unit” shall mean a presently developed or future developed processing unit that executes sequences of instructions contained in a memory, such as memory 116. In one implementation, memory 116 may comprise a non-transit computer-readable medium containing computer readable code, software or programming providing instructions for controller 114. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller wire 14 may be embodied as part of one or more application-specific integrated circuits (ASICs). Unless otherwise specifically noted, the controller is not limited to any specific combination of hardware circuitry and software, nor to any particular source for the instructions executed by the processing unit.

Cash register 102 is connectable to dock 120 so as to communicate with or through dock 120 by a connection interface 118. In one implementation, connection interface 118 comprises a port configured to receive a RJ12 connector. In other implementations, connection interface 118 may comprise a Universal serial bus type port or other type of connection device. In yet another implementation, connection interface 118 may comprise a wireless card or other wireless communication component. In still other implementations, connection interface 118 may be omitted where Dock 120 is permanently contained or incorporated as part of cash register 102.

Portable electronic device 104 comprises an electronic device size and shape Celesta be portable or so as to be manually carried by waiter, salesperson, manager, host or other person involved with commercial transactions. Portable electronic device 104 comprises display 150, user input interface 152, controller 154 in memory 156. Display 150 comprises a display screen to the present visible information, such as graphics and text. User input interface 152 comprises a device to facilitate the entry of information, such as a potential customers identification, in order request, a delivery address and the like, into portable electronic device 104. Examples of user input interface 152 may comprise a touchpad, keypad, miniature keyboard, speech recognition software with an associate a microphone and the like. In one implementation, user input interface 152 may comprise part of display 150 where displayed 150 is a touchscreen.

Controller 154 comprises one or more processing units configured to generate control signals, following instructions contained in memory 156. Controller 154 receives and performs operations in response to commands and information input through interface 152. Controller 154 further directs the presentation of information upon display 150. Examples of such a portable electronic device 104 include, but are not limited to, a tablet, personal data assistant, a smart phone or any other portable electronic device that may be used to take point-of-sale orders. In the example illustrated, memory 156, which comprising non-transient computer-readable medium, contains instructions directing controller 154 to communicate with cash register 102 and dock 120 as will be described below.

Cash register communication interface dock 120 facilitates communication between cash register 102 and portable electronic device 104. As with dock 20, Dock 120 includes portable electronic device interface 22 and cash register interface 24, described above. As specifically shown by FIG. 2, dock 120 also comprises power source 160, memory 162 and controller 164. Power source 160 comprises a source of power for at least portions of cash register 102. In one implementation, power source 160 comprises a battery, such as a rechargeable battery. In another implementation, power source 160 comprises a connection to an electrical outlet.

Memory 162 comprises a non-transient computer-readable medium to be read or processed by controller 164. Memory 162 contains code or other forms of instructions for controller 164. Memory 162 further stores information such as authorized devices 168 and authorization keys 170.

Authorized devices 168 comprises a record or listing of individual portable electronic devices 104 or types/categories of portable electronic devices 104 which are preauthorized for use with dock 120 and the particular individual cash register 102. For example, authorized devices 168 may identify a particular set of individual portable electronic devices 104 (those with particular serial numbers or other unique identification) that are preauthorized for communicating transactions with a particular cash register 102 at a particular location within a store or restaurant.

Authorization keys 170 comprises a record or listing of authorization keys, passwords and the like corresponding to those individuals that are preauthorized for using. 122 communicate between a portable electronic device 104 and cash register 102. For example, authorization keys 170 may comprise a set of passwords which may be consulted by controller 164 to verify that a person connecting to dock 120 with a portable electronic device 104 is authorized for communication with cash register 102 through dock 120. In other implementations, other authorization data be stored in memory 162. In some implementations, such authorization data may be omitted.

Controller 164 comprises one or more processing units configured to follow instructions contained in memory 162 so as to generate control signals facilitating communication with or between portable electronic device 104 and cash register 102. Controller 164 cooperates with controller's 114 and 154 to facilitate secure, yet simplified communication and transactions with cash register 102. In other implementations, controller 164 in memory 162 may be omitted where sons functions are carried out by one or both of controller 114 and 154.

FIG. 3 is a flow diagram illustrating an example method 200 and may be carried out by point-of-sale system 100 of FIG. 2. As indicated by step 202, portable electronic device 104 is docked to dock 120 using portable electronic device interface 22. As noted above, such docking may occur physically, electrically, optically or wirelessly.

As indicated by step 204, communication occurs with cash drawer 102 based upon the docking of portable electronic device 104 to dock 120. In one implementation, in response to receiving access request signals from portable electronic device 104 or in response to sensing the connection of portable electronic device 104 to interface 22, controller 164 may automatically open up a communication channel to cash register unit 102 using interface 24. In another implementation, prior to opening a communication channel, controller 164 may carry out one or more authorization protocols. For example, controller 164 may carry out a device authorization protocol. In one implementation, controller 164 may detect a serial number or other identification characteristic of the particular portable electronic device 104 that is connected to interface 22. Using such information controller 164 may access authorized devices 168 in memory 162 to determine whether the particular portable electronic device is authorized for communication. If the particular portable electronic device 104 is identified or listed in authorized devices 168, controller 164 may open up a communication path between electronic device 104 and cash register 102.

Alternatively, controller 164 may perform an additional a personal authorization protocol or step to ensure that the person using the connected and authorize portable electronic device 104 is also authorized for such communication, preventing stolen portable electronic devices 104 from being inappropriately used to access register 102. In such an implementation, controller 164 may further generate control signals prompting a person in possession of portable electronic device 104 to provide our input authorization information, such as a password. This password may be entered using user input interface 152 of portable electronic device 104 or other input mechanisms. Upon receiving such personal authorization information, controller 164 may then consult authorization key 172 verify that the input personal authorization information corresponds to the personal authorization information or keys and authorization keys 170. If a match is found, controller 164 may open up a communication path between portable electronic device 104 and cash register 102. In some implementations, controller 164 may omit and electronic device authorization protocol, providing access simply upon completion of the aforementioned personal authorization protocol. In other implementations, authorization protocols may be omitted. In yet other implementations, controller 114 of cash register 102 may carry out authorization protocols using dock 120 as an intermediary.

In one implementation, full communication between portable electronic device 104 and cash register 102 is provided upon connection and authorization. In other implementations, access to cash register 102 may be limited by controller 164 of dock 120 depending upon an authorization level granted to the particular portable electronic device 104 (identified in a device authorization protocol) and/or depending upon an authorization level granted to a particular person in possession of portable electronic device 104 (identified in a personal authorization protocol). For example, a first portable electronic device 104 or first person in possession of the first portable electronic device 104 may be provided with limited access to information that may be presented on display 108 of cash register 102, the first person not being provided access to the interior cash drawer 110 or selected portions of the interior of cash drawer 110. At the same time, a second portable electronic device 104 or a second person in possession of the second portable electronic device may be granted greater access to information that may be presented on display 108, the second person being provided access to the interior cash drawer 110.

Once controller 164 opens a communication path to cash register 102, data from the connected portable electronic device 22 may be transferred to the connected cash register unit. As a result, transaction information 176, such as a customer's order, input to the portable electronic device remote from the cash register unit (such as that a customer's table or at a remote location in a store or warehouse) and temporarily stored on the portable electronic device may be transmitted to cash register 102 using interface 24. This information 176 may be presented on display 108 or injured as input to one or more forms or data fields presented for completion on display 108. Thus, this information upon the portable electronic device does not need to be reentered to the cash register 102 when a cash transaction is taking place.

In one example, the uploading or transmission of data from the docked portable electronic device to the connected cash register unit automatically takes place or is automatically triggered in response to connection of the portable electronic device 104 to interface 22 of dock 120. In another implementation, the transfer of data may be delayed despite such connections until authorization is completed. For example, upon being connected to interface 22, transfer data from the portable electronic device to dock 120 may be delayed until the portable electronic device 104 of the person using device 104 has been authorized. Such authorization is carried out by dock 120 itself.

In other implementations, the initiation of the transfer of data may occur, with or without an authorization, in response to the additional step of a person entering a data transfer command to user input interface device 152 of the docked portable electronic device 102 or to a user input interface device associated with cash register 102.

In some implementations, controller 164 may also transfer of data or controls originating with dock 20 in response to connection of portable electronic device 104 to dock 120. For example, in response to a portable electronic device 104 being connected to interface 22 while dock 120 is already connected to a cash register 102, controller 164 may automatically trigger the opening of cash drawer 110 of cash register 102. In one implementation, controller 164 may cause power to be transmitted from power source 160 to lock 112 to actuate lock 112 to an unlocked state. In one implementation, controller 164 may additionally transmit such power or transmit control signals causing cash are one and 12 to be automatically ejected or opened.

In response to portable electronic device 104 being connected interface 22, controller 164 may automatically trigger the presentation of selected data or information 178 upon display 108 of cash register 102. For example, the completion of connection of a portable electronic device to interface 22 may cause controller 164 to itself trigger the display of a particular graphical user interface, icon or other data upon the display of the cash register 102. As a result, a salesperson, waiter or host a simply need to connect his or her portable electronic device to automatically bring up an appropriate menu, order form or screen, inventory listing, delivery information or schedule, credit rating, customer data or history and the like on the display 108 of the cash register 102 to facilitate such a commercial transaction. In other implementations, the automatic presentation of information on a display of the cash register unit may alternatively be triggered by completion of additional steps such as the additional step of authorization, wherein different information is presented on display 108 depending upon the particular authorization associated with a particular electronic device 104 or the person in possession electronic device 104.

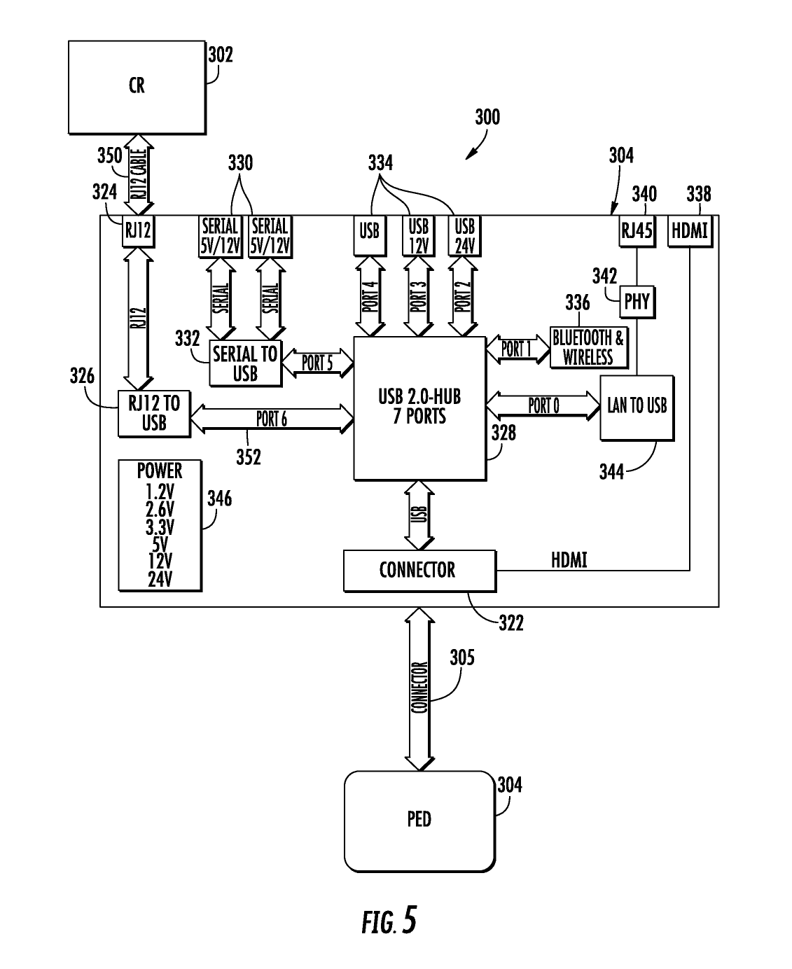

FIG. 4 schematically illustrates point-of-sale system 250, an example implementation of point-of-sale system 100. Point-of-sale system 250 is similar to point- of-sale system 100 except that point-of-sale system 250 comprises cash register 252 instead of cash register 102. For ease of illustration and discussion, those remaining components of point-of-sale system 250 which correspond to components of point-of-sale system 100 are numbered similarly.

Cash register 252 is similar cash register 102 except that cash register 252 omits display 108. In contrast to cash register 102, cash register 252 does itself not visibly present information, but instead utilizes the display 150, connected via dock 120, to display such information. In some implementations, cash register 252 may simply perform such operations as opening and closing cash drawer 110, whereas the electronic accounting, input of data or storing of transaction data is itself also carried out by portable electronic device 104. In such an implementation, because cash register 252 largely serves as a cash drawer and takes advantage of the processing, memory and display capabilities of portable electronic device 104 attached by dock 120, cash register 252 may be provided with much less processing power (a much less complex controller 114 or memory 116), permitting the complexity and cost of cash register 252 to be greatly reduced.

Cash register 252 comprises an electronic, electric or computerized cash drawer which facilitates commercial transactions involving cash or other currency. Cash register 0252 comprises power switch 106, display 108, cash drawer 110, lock 112, controller 114 and memory 116.

Power switch 106 comprises a button, toggle other device by which a person may manually power or turn on cash register 102.

Cash drawer 110 comprises a currency containing and receiving drawer or other chamber movable between an open state or position (shown in FIG. 2) providing access to its interior and a closed position retracted within the body of cash register 102, denying access to its interior. Lock 112 comprises a mechanism by which cash drawer 110 may be selectively retained in the closed position. In the example illustrated, lock 112 is configured to be electrically controlled or actuated between a locked state securing drawer 110 and an unlocked state. Although lock 112 is illustrated as being configured to receive a physical key for actuation in addition to electronically controlled actuation, in other implementations, lock 112 may alternatively be actuated solely by electronic or electrical actuation, such as in response to signals from controller 114.

Controller 114 comprises one or more processing units configured to generate control signals directing the actuation of lock 112 and the opening of cash drawer 110. Cash register 102 is connectable to dock 120 so as to communicate with or through dock 120 by a connection interface 118. In one implementation, connection interface 118 comprises a port configured to receive a RJ12 connector. In other implementations, connection interface 118 may comprise a Universal serial bus type port or other type of connection device. In yet another implementation, connection interface 118 may comprise a wireless card or other wireless communication component. In still other implementations, connection interface 118 may be omitted where Dock 120 is permanently contained or incorporated as part of cash register 102.

Point-of-sale system 250 operates in a similar fashion to point-of-sale system 100. In operation, communication occurs with cash drawer 252 based upon the docking of portable electronic device 104 to dock 120. In one implementation, in response to receiving access request signals from portable electronic device 104 or in response to sensing the connection of portable electronic device 104 to interface 22, controller 164 may automatically open up a communication channel to cash register unit 102 using interface 24. In another implementation, prior to opening a communication channel, controller 164 may carry out one or more authorization protocols. For example, controller 164 may carry out a device authorization protocol. In one implementation, controller 164 may detect a serial number or other identification characteristic of the particular portable electronic device 104 that is connected to interface 22. Using such information controller 164 may access authorized devices 168 in memory 162 to determine whether the particular portable electronic device is authorized for communication. If the particular portable electronic device 104 is identified or listed in authorized devices 168, controller 164 may open up a communication path between electronic device 104 and cash register 102.

Alternatively, controller 164 may perform an additional a personal authorization protocol or step to ensure that the person using the connected and authorize portable electronic device 104 is also authorized for such communication, preventing stolen portable electronic devices 104 from being inappropriately used to access register 102. In such an implementation, controller 164 may further generate control signals prompting a person in possession of portable electronic device 104 to provide our input authorization information, such as a password. This password may be entered using user input interface 152 of portable electronic device 104 or other input mechanisms. Upon receiving such personal authorization information, controller 164 may then consult authorization key 172 verify that the input personal authorization information corresponds to the personal authorization information or keys and authorization keys 170. If a match is found, controller 164 may open up a communication path between portable electronic device 104 and cash register 102. In some implementations, controller 164 may omit and electronic device authorization protocol, providing access simply upon completion of the aforementioned personal authorization protocol. In other implementations, authorization protocols may be omitted. In yet other implementations, controller 114 of cash register 252 may carry out authorization protocols using dock 120 as an intermediary.

In one implementation, full communication between portable electronic device 104 and cash register 102 is provided upon connection and authorization. In other implementations, access to cash register 102 may be limited by controller 164 of dock 120 depending upon an authorization level granted to the particular portable electronic device 104 (identified in a device authorization protocol) and/or depending upon an authorization level granted to a particular person in possession of portable electronic device 104 (identified in a personal authorization protocol). For example, a first portable electronic device 104 or first person in possession of the first portable electronic device 104 may be provided with limited access to the interior cash drawer 110 or selected portions of the interior of cash drawer 110. At the same time, a second portable electronic device 104 or a second person in possession of the second portable electronic device may be granted greater access to the interior cash drawer 110.

In some implementations, controller 114 in memory 116 of cash register 252 may comprise an application-specific integrated circuit controlling the authorization for access to the interior of cash drawer 110 and the opening of cash or 110 itself. In another implementation, cash register 252 may omit controller 114, memory 116, and possibly power switch 106, wherein dock 120 carries out all authorization protocols with regard to electronic device 104 and wherein dock 120 simply provides power to cash register 102 upon such authorization by dock 120 so as to power and actuate the electronic or electric lock 112. In such an implementation, dock 120 facilitates a great reduction in the cost and complexity of cash register 252.

FIG. 5 schematically illustrates point-of-sale system 300, an example of limitation of system 100. Point-of-sale system 300 comprises cash register 302, portable electronic device 304 and dock 320. Cash register 302 is substantially identical to cash register 102 shown and described above with respect to FIG. 2. Portable electronic device 304 is substantially similar portable electronic device 104 described above with respect to FIG. 2. In one particular embodiment, portable electronic device 304 comprises a tablet computing device with a touch screen display 150 (shown in FIG. 2). Portable electronic device 304 in figure to be connected to dock 304 using a connector 305 (schematically shown).

Dock 304 serves as an intermediary between portable electronic device 304 and cash register 302. Dock 304 comprises portable electronic device communication interface 322, cash register interface 324, translator 326, called room 328, serial ports 330, translated 332, USB ports 334, wireless module 336, HDMI port 338, RJ-45 ethernet port 340, physical layer (PHY) 342, USB LAN adapter 344 and power source 346. Portable electronic device communication interface 322 comprising interface configured to connect to portable electronic device 304 for data communication between dock 320 and device 304. In the example illustrated, interface 322 comprises a USB port. In other implementations, interface 322 comprises other types of interfaces.

Cash register communication interface 324 comprises an RJ12 connector connected to cash register 302 by a RJ12 cable 350. Translator 326 receives RJ12 formatted signals from interface 324 and translates or converts such signals to USB signals which are transmitted to hub 328 as indicated by arrows 352. Hub 328 forms a communication path between the portable electronic device 304 and cash register 302. Hub 328 further facilitates connection in communication between cash register 302 and device 304 using other parts associated with dock 320. In the example illustrated, of 328 comprises a USB 2.0 hub having seven ports. In one of limitation, hub 328 comprises a low power, OEM configurable hub controller commercial identified as SMSC 2517. In other implementations, hub 328 may be other configurations or may be omitted.

The additional ports of dock 320 log. 322 connect one or both of cash register 302 and device 324 other devices. For example, serial port 330 and serial to USB translator 332 facilitate connection of dock 322 devices employing such serial connectors. USB port 334 facilitate connection to other devices using USB connectors. Bluetooth or wireless module 336 facilitates wireless communication, via radio frequency, to other devices and wireless fashion. RJ-45 port 340, physical layer 342 and LAN to USB adapter 344 (commercially available as an Elite Silicon E3868M6) facilitate communication with devices via a local area network cable or connector. Such serial ports, USB ports and the RJ-45 port facilitate connection of dock 320 to devices such as handheld scanners, barcode readers, display polls and the like. HDMI port 338 facilitates connection to a display monitor such as a customer facing display connected to or docked to dock 320. Power source 346 facilitates the provision of power to charge device 304 through a USB connector and/or to unlock and eject a cash drawer associated with cash register 302, such as cash drawer 110 shown in FIG. 2.

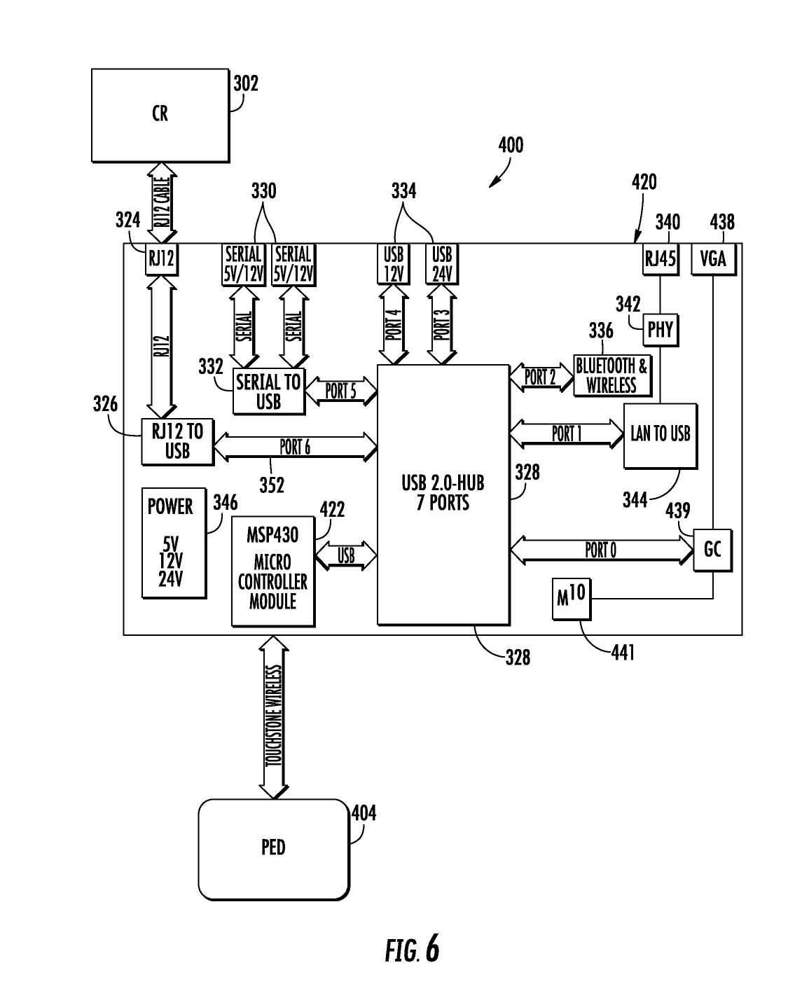

FIG. 6 schematically illustrates point-of-sale system 400, the example implementation of point-of-sale system 100. Point-of-sale system 400 is similar to point-of-sale system 300 except that system 400 comprises dock 420 configured for connection to a portable electronic device 404. Portable electronic device 404 comprises a portable electronic device similar to portable electronic device 104 shown in FIG. 2. In one implementation, device 404 comprises a multi-touch capacitive touchscreen tablet computer configured to communicate with dock 420 using magnetic induction such as Palm's TOUCHSTONE technology. In other implementations, portable electronic device 404 may have other configurations and may be configured to connector communicate with dock 420 in other fashions.

Dock 420 is similar to dock 320 except that dock 420 comprises portable electronic device communication interface 422 in place of interface 322, VGA port 438 in place of HDMI port 338, USB graphics controller 439 and memory 441. Those remaining components of dock 420 which correspond to components of dock 320 are numbered similarly.

VGA port 438 comprises a port configured to connect to an external video graphics array monitor or display. USB graphics controller 439 interfaces with VGA port 438 to serve as a graphics controller. In one implementation, graph controller 439 comprises a commercially available SMSC UFX6000. In other implementations other graphic controllers may be utilized. Memory 441 device memory for graphics controller 439. In one implementation, memory 441 comprises a 512 MB DDR 800 memory device. In other embodiments, other forms of memory may be provided for graphics controller 439. In other implementations, one or more of such ports and associated components may be omitted from dock 420 or may be replaced with other communication ports and components.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a dock comprising:
a portable electronic device communication interface to communicate with a portable electronic device having a user input interface;
a cash register communication interface to communicate with a cash register; and
a communication path communicatively coupling the portable electronic device communication interface and the cash register communication interface.

2. The apparatus of claim 1 further comprising a controller to generate control signals causing a cash drawer of the cash register to open based upon connection to the portable electronic device to the dock.

3. The apparatus of claim 2, wherein the controller is configured to transmit transaction information from the portable electronic device to the cash register through the dock.

4. The apparatus of claim 3, wherein the controller is configured to transmit transaction information from the portable electronic device to the cash register automatically in response to docking of the portable electronic device.

5. The apparatus of claim 1, wherein the dock further comprises:
a memory storing an authorization key for authorizing a portable electronic device; and
a controller for authorizing a portable electronic device connected to the dock using the stored authorization key, wherein the controller is configured to transmit control signals across the cash register communication interface to open the cash register in response to authorization of the portable electronic device.

6. The apparatus of claim 2, wherein the dock is configured to provide power to the cash register to open the cash register based upon connection of the portable electronic device to the dock.

7. The apparatus of claim 1, wherein the communication interface comprises a wireless port to wirelessly communicate with the portable electronic device.

8. The apparatus of claim 1, wherein the communication interface comprises a physical port or physical connection to the portable electronic device.

9. The apparatus of claim 1, wherein the cash register communication interface comprises a wireless port to wirelessly communicate with the cash register.

10. The apparatus of claim 1, wherein the cash register communication interface comprises a physical port to physically connect the dock to the cash register.

11. The apparatus of claim 1, wherein the cash register comprises a display and wherein the dock is configured to automatically trigger presentation of selected information upon the display when connected to the dock based upon connection of a portable electronic device to the portable electronic device interface.

12. A point-of-sale system comprising:
a cash register having a cash drawer; and
a dock connected to the cash register, the dock comprising:
a portable electronic device communication interface to communicate with a portable electronic device having a user input interface; and
a communication path communicatively coupling the portable electronic device communication interface and the cash register.

13. A method comprising:
docking a portable electronic device to a dock; and
communicating with the cash register based upon the docking of the portable electronic device.

14. The method of claim 13 further comprising opening the cash register based upon the docking of the portable electronic device.

15. The method of claim 14 further comprising storing an authorization key on the portable electronic device, wherein the opening of the cash register is based upon an authorization using the authorization key.
